(19) United States
(12) Patent Application Publication
(10) Pub. No.: US 2010/0146425 A1
(43) Pub. Date: Jun. 10, 2010

(54) DRAG AND DROP TARGET INDICATION IN A GRAPHICAL USER INTERFACE

(76) Inventors: John M. Lance, Littleton, MA (US); Margo L. Ezekiel, Newton, MA (US)

Correspondence Address: HOFFMAN WARNICK LLC, 75 STATE STREET, 14TH FLOOR, ALBANY, NY, 12207, US

(21) Appl. No.: 12/329,768

(22) Filed: Dec. 8, 2008

(51) Int. Cl. G06F 3/048

(52) U.S. Cl. 715/769

(57) ABSTRACT

The invention provides a method, system, and program product for indicating a drag and drop target in a graphical user interface. In one embodiment, the invention includes indicating at least one target within the GUI onto which a selected object may be dropped, changing the indication of the at least one target based upon the selected object being dragged within the GUI, and providing an indication of a result of dropping the selected object on the at least one target, wherein indicating is aggregated for a plurality of targets and changing the indication includes deaggregating the indication.

### TECHNICAL FIELD

The present invention relates generally to graphical user interfaces (GUIs) and, more particularly, to indicating a drag and drop target indication within a GUI.

### BACKGROUND OF THE INVENTION

Many computer operating systems and computer software programs support “drag and drop” movement and/or copying of data objects within a graphical user interface (GUI). This technique involves the selection of an object using an input device (e.g., mouse, tablet, etc.), movement of the selected object within the GUI using the same or a different input device, and “dropping” or deselecting the object onto a target (e.g., an application window, a representation of an internal or external storage device, etc.). Upon dropping the object onto a target, some action of a plurality of actions may be taken automatically or manually with respect to the object (e.g., copying the object into a new electronic mail message, moving or copying the object to another location or device, etc.).

One deficiency of the drag and drop technique, however, is the fact that not all “targets” within the GUI are, in fact, suitable targets onto which the selected object may be dropped. For example, dropping a data object having an unsupported file format onto an application window may result, at best, in the application simply not recognizing the data object. Worse, the application itself may be corrupted or otherwise made unavailable as it attempts to process or access the data object.

Yet another deficiency of the drag and drop technique is that, unless determined by trial-and-error, a user may not know what actions will be taken when the object is dropped on a particular target.

Accordingly, there exists a need in the art to overcome the deficiencies and limitations described hereinabove.

### SUMMARY OF THE INVENTION

The invention provides a method, system, and program product for indicating a drag and drop target in a graphical user interface (GUI).

A first aspect of the invention provides a method of indicating a drag and drop target in a graphical user interface (GUI), the method comprising: indicating at least one target within the GUI onto which a selected object may be dropped; and changing the indication of the at least one target based upon the selected object being dragged within the GUI.

A second aspect of the invention provides a system for indicating a drag and drop target in a graphical user interface (GUI), the system comprising: a system for indicating at least one target within the GUI onto which a selected object may be dropped; and a system for changing the indication of the at least one target based upon the selected object being dragged within the GUI.

A third aspect of the invention provides a program product stored on a computer-readable medium, which when executed, indicates a drag and drop target in a graphical user interface (GUI), the program product comprising: program code for indicating at least one target within the GUI onto which a selected object may be dropped; and program code for changing the indication of the at least one target based upon the selected object being dragged within the GUI.

A fourth aspect of the invention provides a method for deploying an application for indicating a drag and drop target in a graphical user interface (GUI), comprising: providing a computer infrastructure being operable to: indicate at least one target within the GUI onto which a selected object may be dropped; and change the indication of the at least one target based upon the selected object being dragged within the GUI.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-6 show the indication of drag and drop targets within graphical user interfaces (GUIs) according to various embodiments of the invention;

FIG. 7 shows a flow diagram of an illustrative method according to the invention; and

FIG. 8 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

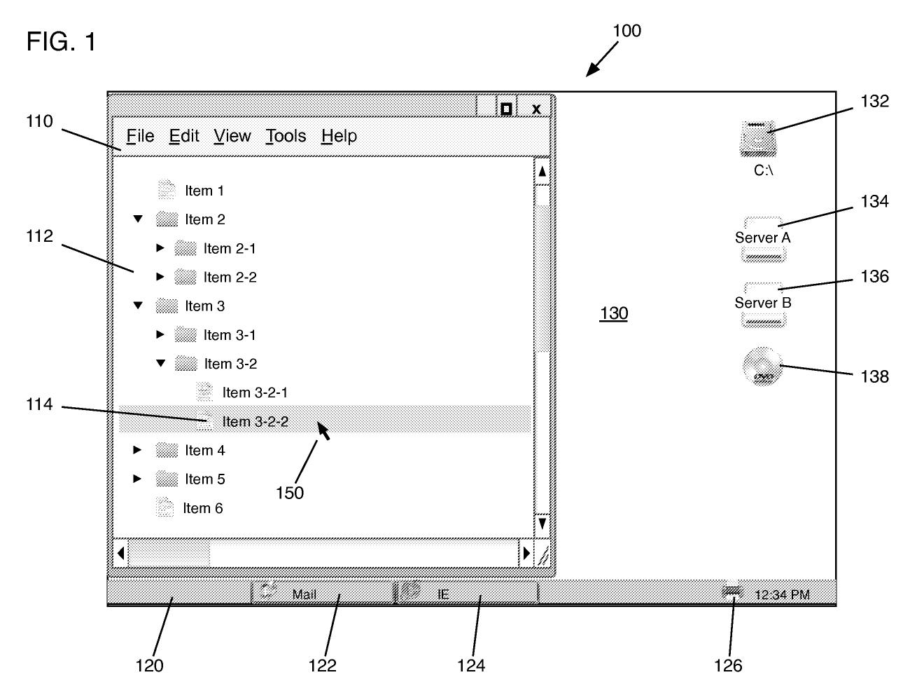

FIG. 1 shows a graphical user interface (GUI) 100 including a window 110, a task bar 120, and a desktop 130. The window 110 shows a file structure 112, including a selected object 114. As shown in FIG. 1, the selected object 114 is selected using a mouse arrow 150, although other selection techniques may be employed. The task bar 120 includes application tabs 122, 124 and a print icon 126. The desktop 130 shows integrated, networked, and peripheral devices, namely, the computer hard drive 132, two networked servers 134 (Server A), 136 (Server B), and a recordable disc 138.

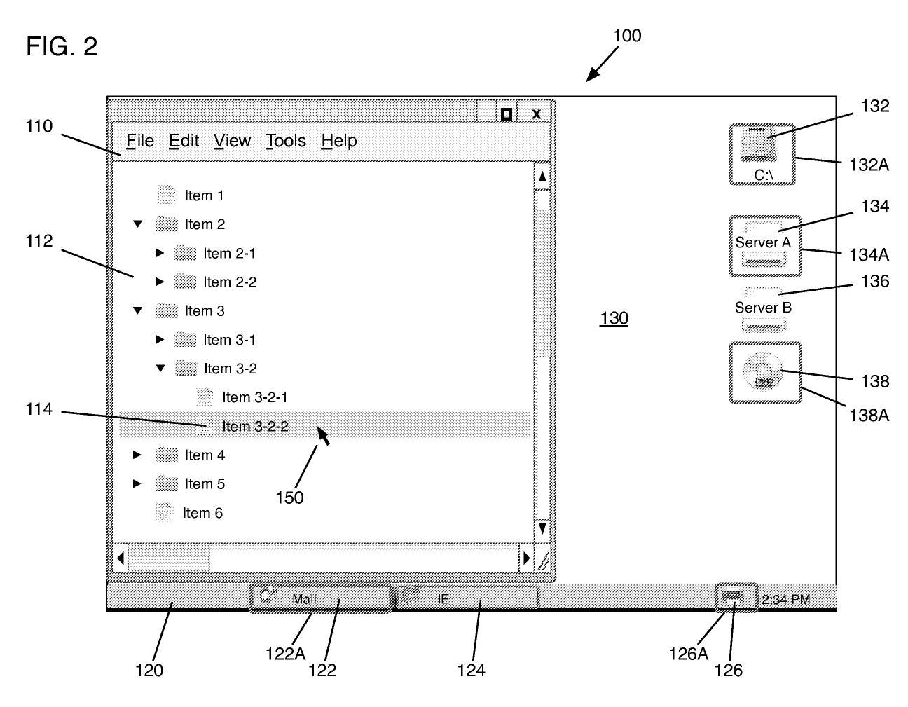

In FIG. 2, it can be seen that the targets onto which the selected object 114 may be dropped (i.e., application tab 122, print icon 126, the computer hard drive 132, Server A 134, and the recordable disc 138) are indicated with colored outlines (122A, 126A, 132A, 134A, 138A, respectively). As can be seen, application tab 124 and Server B 136 are not indicated as targets onto which the selected object may be dropped. This may be attributable to an incompatibility between the selected object 114 and the non-target (e.g., the selected object 114 is of a type that cannot be opened or otherwise used or manipulated by the non-target) or privileges of the user (e.g., the user may not have sufficient privileges to move the selected object 114 to Server B 136).

While the indication of targets is shown in FIG. 2 with colored outlines, it should be noted that any method or technique for distinguishing targets onto which the selected object 114 may be dropped from other portions of the GUI may be used. For example, targets may be left unchanged while non-target portions of the GUI are dimmed, targets may be magnified while non-target portions of the GUI are left unchanged, or some other indicator may be placed on or adjacent targets. Other methods and techniques will be known to one skilled in the art and are within the scope of the invention, the embodiment shown in FIG. 2 being for purposes of illustration only.

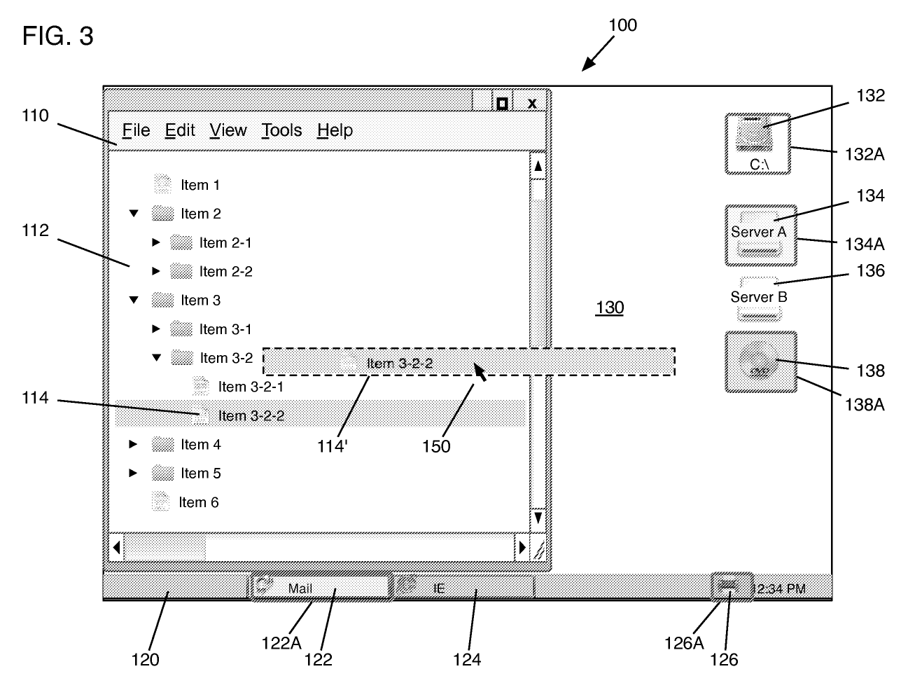

In FIG. 3, it can be seen that as the dragged object 114′ is moved within the GUI, the indication of targets changes. Here, the areas within the colored outlines 122A, 126A, 132A, 134A, 138A, covering the targets themselves, are shaded. As can be seen, the shading is darker for targets closer to the dragged object 114′ and lighter for targets further from the dragged object 114′. As the dragged object 114′ is moved through the GUI, such shading changes. While the change in target indication is shown in FIG. 3 as shading and changes in shading, any other method or technique for changing such target indication may be used and may depend, for example, on the method or technique for initially indicating the targets.

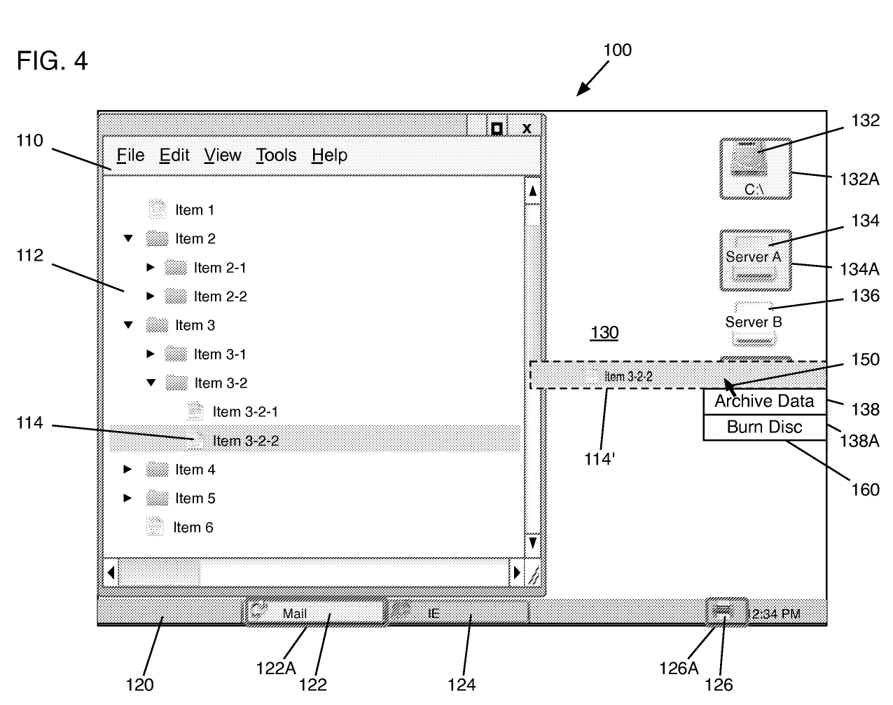

FIG. 4 shows another embodiment of the invention, wherein an indication is provided of the result of dropping the dragged object 114′ on a particular target. Here, a menu 160 is provided showing the possible actions to be taken (archive data or burn disc) upon dropping the dragged object 114′ onto the recordable disc 138. As shown in FIG. 4, the menu 160 is provided when the mouse arrow 150 passes over the recordable disc 138. In other embodiments, the menu 160 or some other indication of the result of dropping the dragged object 114′ may be provided differently (e.g., as the dragged object 114′ nears the target or upon initial selection of the selected object 114).

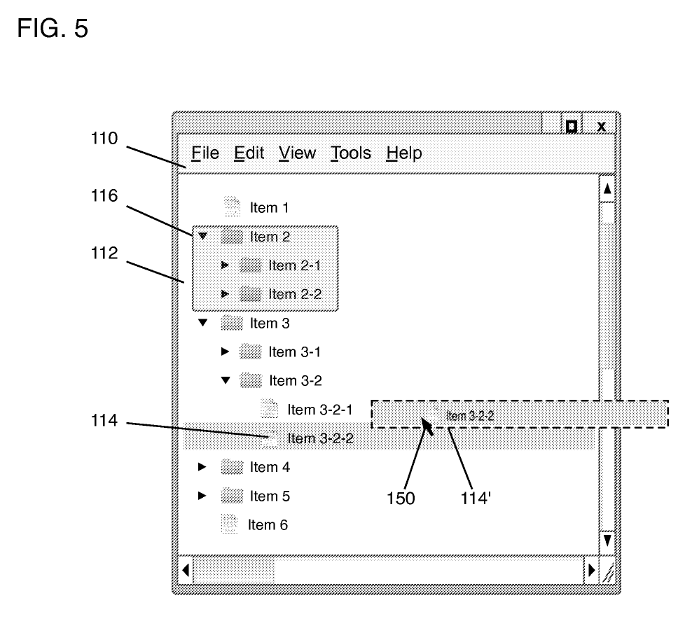

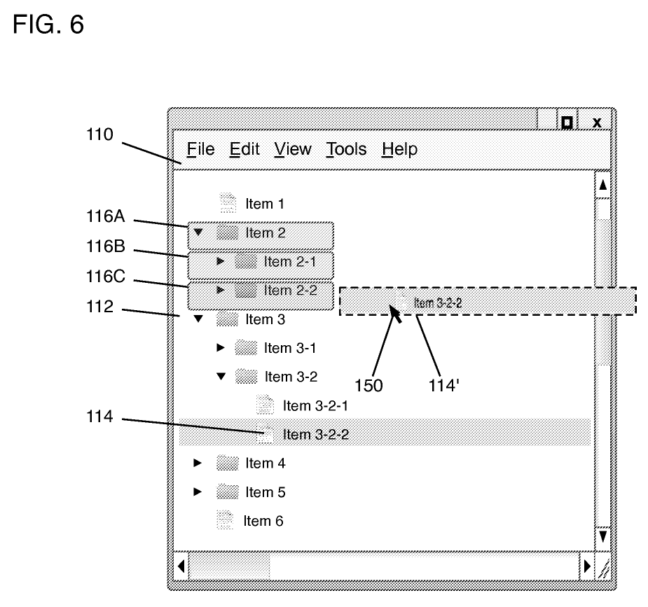

FIGS. 5-6 show yet another embodiment of the invention, wherein target indication is aggregated and then deaggregated for a plurality of targets. In FIG. 5, the dragged object 114′ may be dropped onto Item 2 or either of its subfolders (Item 2-1 and Item 2-2), as shown by the aggregated colored outline 116. In FIG. 6, as the dragged object 114′ nears the targets, the target indication is deaggregated by providing distinct colored outlines 11 6A-C and shading for each target. As can be seen in FIG. 6, shading is again darker for targets closer to the dragged object 114′ (i.e., Item 2-2) than for targets further from the dragged object 114′ (i.e., Item 2).

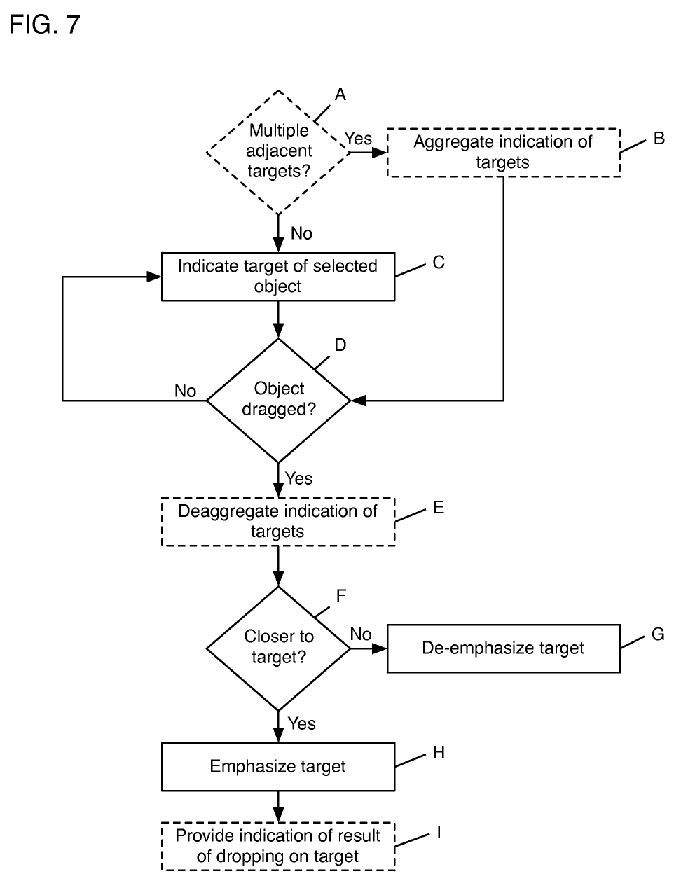

FIG. 7 shows a flow diagram of an illustrative method according to an embodiment of the invention. At A, it may optionally be determined whether there are multiple adjacent or nearby targets onto which a selected object may be dropped. If so, the indication of the targets may be aggregated at B. If not, or if no such determination is made, a target onto which the selected object may be dropped is indicated at C.

At D, it is determined whether the selected object has been dragged within the GUI. If not, indication of the target is continued (i.e., C and D may be iteratively looped). If the selected object has been dragged within the GUI, the aggregated indication of targets (at B) may optionally be deaggregated at E. In any case, it is determined at F whether the dragged object has been moved closer to the indicated target. If so, the target may be emphasized (e.g., darker shading, magnification, etc.) at H. If not (i.e., the dragged object has been moved farther from the indicated target), the target may be de-emphasized (e.g., lighter shading, dimming, etc.) at G.

As noted above, at I, an indication of a result of dropping the selected object on the target may be provided. It should be noted that the provision of such an indication may be made at another point within the flow shown in FIG. 7, the particular flow shown being for purposes of illustration only.

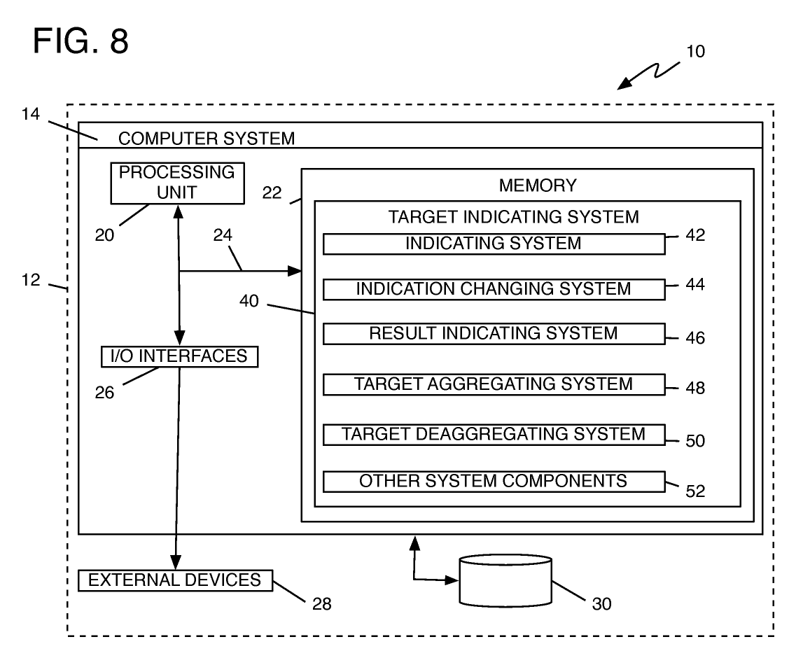

FIG. 8 shows an illustrative system 10 for indicating a drag and drop target in a GUI. To this extent, system 10 includes a computer infrastructure 12 that can perform the various process steps described herein for indicating a drag and drop target in a GUI. In particular, computer infrastructure 12 is shown including a computer system 14 that comprises target indicating system 40, which enables computer system 14 to indicate a drag and drop target in a GUI by performing the process steps of the invention.

Computer system 14 is shown including a processing unit 20, a memory 22, input/output (I/O) interfaces 26, and a bus 24. Further, computer system 14 is shown in communication with external devices 28 and a storage system 30. As is known in the art, in general, processing unit 20 executes computer program code, such as target indicating system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and target indicating system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, the target indicating system 40 enables the computer system 14 to indicate a drag and drop target in a GUI. To this extent, the target indicating system 40 is shown including an indicating system 42, an indication changing system 44, a result indicating system 46, a target aggregating system 48, and a target deaggregating system 50. Operation of each of these systems is discussed above. The target indicating system 40 may further include other system components 52 to provide additional or improved functionality to the target indicating system 40. It is understood that some of the various systems shown in FIG. 8 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for indicating a drag and drop target in a GUI, it is understood that the invention further provides various alternative embodiments. For example, in one embodiment, the invention provides a computer-readable medium that includes computer program code to enable a computer infrastructure to indicate a drag and drop target in a GUI. To this extent, the computer-readable medium includes program code, such as target indicating system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to indicate a drag and drop target in a GUI, as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for indicating a drag and drop target in a GUI. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of indicating a drag and drop target in a graphical user interface (GUI), the method comprising:
indicating at least one target within the GUI onto which a selected object may be dropped; and
changing the indication of the at least one target based upon the selected object being dragged within the GUI.

2. The method of claim 1, further comprising:
providing an indication of a result of dropping the selected object on the at least one target.

3. The method of claim 1, wherein indicating includes providing an outline of the at least one target.

4. The method of claim 3, wherein the outline is colored.

5. The method of claim 3, wherein changing the indication of the at least one target includes changing the outline of the at least one target.

6. The method of claim 1, wherein changing the indication of the at least one target includes shading the at least one target.

7. The method of claim 6, wherein the shading of the at least one target is darkened if the selected object is dragged toward the at least one target.

8. The method of claim 6, wherein the shading of the at least one target is lightened if the selected object is dragged away from the at least one target.

9. The method of claim 1, wherein indicating is aggregated for a plurality of targets and changing the indication includes deaggregating the indication.

10. A system for indicating a drag and drop target in a graphical user interface (GUI), the system comprising:
a system for indicating at least one target within the GUI onto which a selected object may be dropped; and
a system for changing the indication of the at least one target based upon the selected object being dragged within the GUI.

11. The system of claim 10, further comprising:
a system for providing an indication of a result of dropping the selected object on the at least one target.

12. The system of claim 10, wherein indicating includes providing an outline of the at least one target.

13. The system of claim 12, wherein changing the indication of the at least one target includes changing the outline of the at least one target.

14. The system of claim 10, wherein changing the indication of the at least one target includes shading the at least one target.

15. The system of claim 14, wherein the shading of the at least one target is darkened if the selected object is dragged toward the at least one target and the shading of the at least one target is lightened if the selected object is dragged away from the at least one target.

16. The system of claim 10, wherein indicating is aggregated for a plurality of targets and changing the indication includes deaggregating the indication.

17. A program product stored on a computer-readable medium, which when executed, indicates a drag and drop target in a graphical user interface (GUI), the program product comprising:
program code for indicating at least one target within the GUI onto which a selected object may be dropped; and
program code for changing the indication of the at least one target based upon the selected object being dragged within the GUI.

18. The program product of claim 17, further comprising:
program code for providing an indication of a result of dropping the selected object on the at least one target.

19. The program product of claim 17, wherein changing the indication of the at least one target includes shading the at least one target such that the shading of the at least one target is darkened if the selected object is dragged toward the at least one target and the shading of the at least one target is lightened if the selected object is dragged away from the at least one target.

20. The program product of claim 17, wherein indicating is aggregated for a plurality of targets and changing the indication includes deaggregating the indication.

21. A method for deploying an application for indicating a drag and drop target in a graphical user interface (GUI), comprising:
providing a computer infrastructure being operable to:
indicate at least one target within the GUI onto which a selected object may be dropped; and
change the indication of the at least one target based upon the selected object being dragged within the GUI.
